(19) United States
(12) Patent Application Publication
(10) Pub. No.: US 2016/0068096 A1
(43) Pub. Date: Mar. 10, 2016

(54) Load Securing Assembly

(71) Applicant: Ron Hood, Yuba City, CA (US)

(72) Inventor: Ron Hood, Yuba City, CA (US)

(21) Appl. No.: 14/478,109

(22) Filed: Sep. 5, 2014

(51) Int. Cl. B60P 7/08; F16B 2/24

(52) U.S. Cl. CPC B60P 7/08; F16B 2/248

(57) ABSTRACT

A load securing assembly includes a pair of clips structured to have a first section, a second section and a third section. The second section of the clips may engage a bed of a truck so clips are retained on the bed of the truck. The first section of the clips may have a strap coupled thereto. The strap secures a load in the bed of the truck.

### BACKGROUND OF THE DISCLOSURE

### Field of the Disclosure

The disclosure relates to securing devices and more particularly pertains to a new securing device for securing a load in a truck.

### SUMMARY OF THE DISCLOSURE

An embodiment of the disclosure meets the needs presented above by generally comprising a pair of clips structured to have a first section, a second section and a third section. The second section of the clips may engage a bed of a truck so clips are retained on the bed of the truck. The first section of the clips may have a strap coupled thereto. The strap secures a load in the bed of the truck.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a load securing assembly according to an embodiment of the disclosure.

FIG. 2 is a front view of an embodiment of the disclosure.

FIG. 3 is a right side view of an embodiment of the disclosure.

FIG. 4 is a bottom view of an embodiment of the disclosure.

FIG. 5 is an in-use view of an embodiment of the disclosure.

### DESCRIPTION OF THE PREFERRED EMBODIMENT

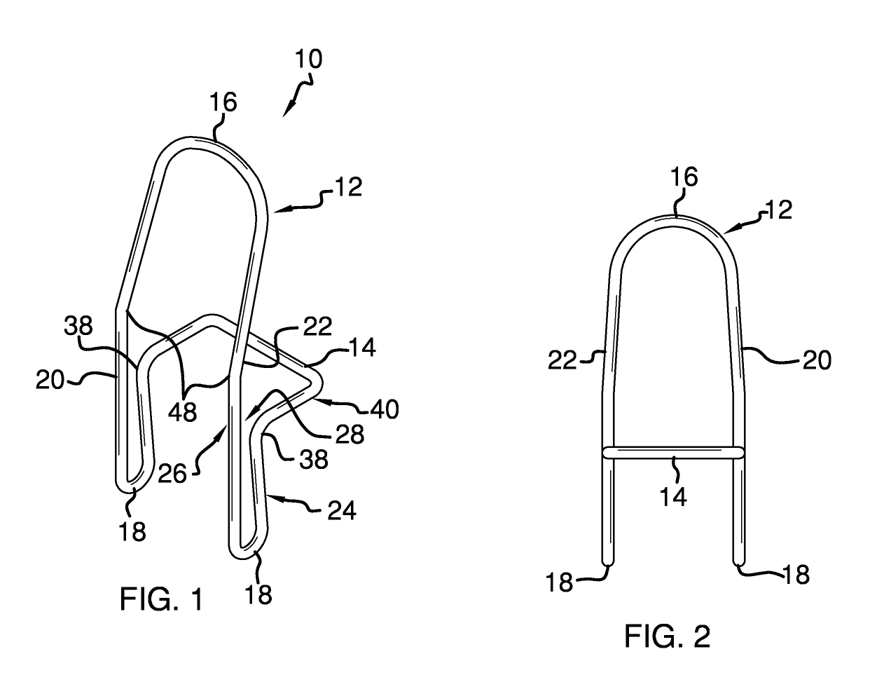

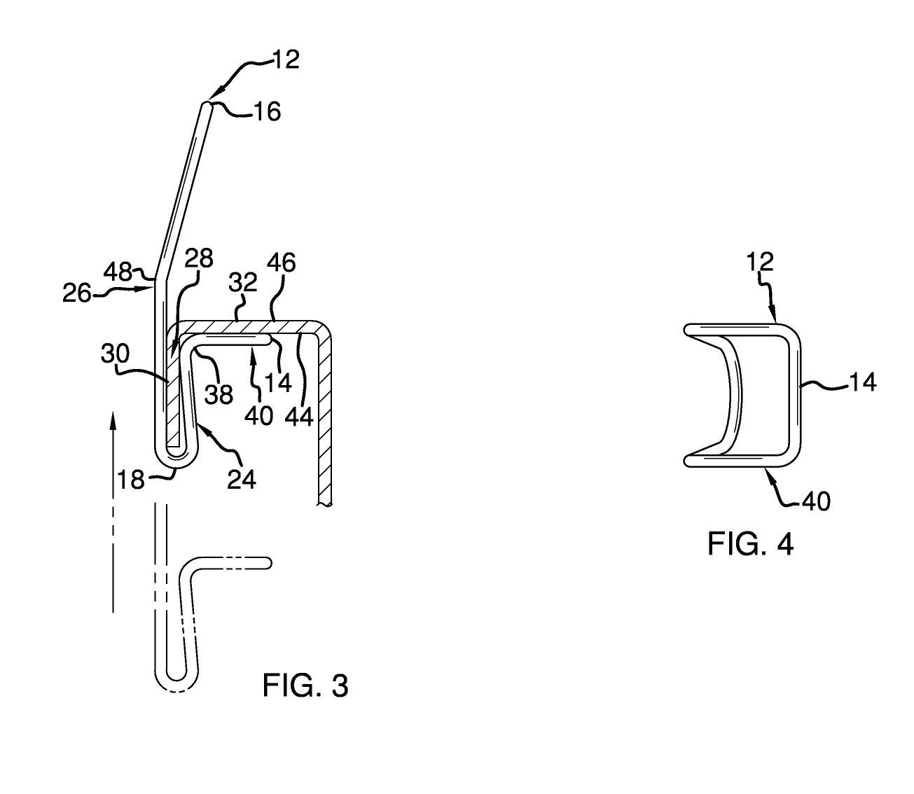

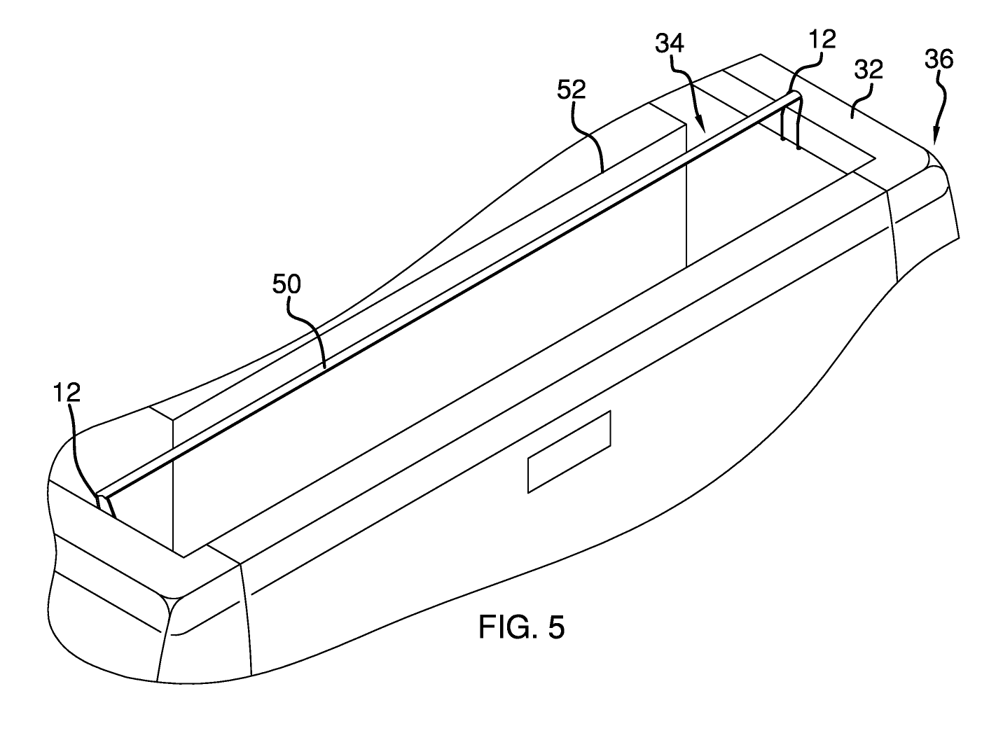

With reference now to the drawings, and in particular to FIGS. 1 through 5 thereof, a new securing device embodying the principles and concepts of an embodiment of the disclosure and generally designated by the reference numeral 10 will be described.

As best illustrated in FIGS. 1 through 5, the load securing assembly 10 generally comprises a pair of clips 12 each comprising a continuous member. The clips 12 form an ovoid shape that has a first end 14 and a second end 16. The clips 12 each has a pair of first bends 18 positioned on an associated one of a first lateral side 20 and a second lateral side 22 of the clips 12. The first bends 18 define a second section 24 of the clips 12 extending upwardly along side a first section 26 of the clips 12.

The second section 24 of the clips 12 is spaced apart from the first section 26 of the clips 12. A channel 28 is defined between the first 26 and second 24 sections of the clips 12. The channel 28 may to insertably receive an inner side 30 of a top edge 32 of a bed 34 on a truck 36 so the clips 12 are retained on the bed 34 of the truck 36. The second end 16 of the clips 12 is directed upwardly from the top edge 32 of the bed 34 of the truck 36. Moreover, the truck 36 may be a pickup of any conventional design.

The clips 12 each has a pair of second bends 38 located on each of the first 20 and second 22 lateral sides of the clips 12. The second bends 38 are positioned between the first bends 18 and the second end 16 of the clips 12. Additionally, the second bends 38 define a third section 40 of the clips 12. The third section 40 of the clips 12 is directed forwardly from the second section 24 of the clips 12. The third section 40 of the clips 12 may abut a bottom surface 44 of a top side 46 of the top edge 32 of the bed 34 of the truck 36 when the clips 12 are coupled to the top edge 32 of the bed 34 of the truck 36. Moreover, the third section 42 of the clips 12 prevents the clips 12 from being urged upwardly on the bed 34 of the truck 36.

The clips 12 each has a pair of third bends 48 located on the first 20 and second 22 lateral sides of the clips 12. The third bends 48 are positioned between the first bends 18 and the second end 16 of the clips 12. Additionally, the second end 16 of the clips 12 is directed outwardly from the bed 34 of the truck 36 when the clips 12 are coupled to the bed 34 of the truck 36.

In use, the clips 12 are coupled to opposite sides of the bed 34 of the truck 36. The clips 12 are further positioned at a selected point along the length of the bed 34 of the truck 36. A strap 50 is coupled between the second ends 16 of each of the clips 12. The strap 50 is used to secure a load 52 in the bed 34 of the truck 36.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A load securing assembly comprising:
a pair of clips, each clip being structured to have a first section, a second section and a third section, said clips each having a pair of first bends positioned on an associated one of a first lateral side and a second lateral side of said clips to define said second section of said clips extending upwardly along side and towards said first section of said clips, said second section of said clips being spaced apart from said first section of said clips such that a channel is defined between said first and second sections of said clips wherein said channel is configured to insertably receive an inner side of a top edge of the bed on the truck having said second end of said clips being directed upwardly from the top edge of the bed of the truck, said third section of said clips being directed forwardly from said second section of said clips such that said third section of said clips is configured to abut a bottom surface of a top side of the top edge of the bed of the truck, an upper portion of each said first section being angled relative to a lower portion of said first section such that said upper portion extends over said third section and
said first section of said clips being configured to have a strap coupled thereto wherein the strap secures a load in the bed of the truck.

2. The assembly according to claim 1, further comprising said clips each comprising a continuous member such that said clips forms an ovoid shape having a first end and a second end.

3. (canceled)

4. (canceled)

5. The assembly according to claim 1, further comprising said clips each having a pair of second bends located on each of said first and second lateral sides of said clips such that said second bends are positioned between said first bends and said second end of said clips to define said third section of said clips.

6. (canceled)

7. A load securing assembly comprising:
a pair of clips each comprising a continuous member such that said clips forms an ovoid shape having a first end and a second end;
said clips each having a pair of first bends positioned on an associated one of a first lateral side and a second lateral side of said clips to define a second section of said clips extending upwardly along side and towards a first section of said clips, said second section of said clips being spaced apart from said first section of said clips such that a channel is defined between said first and second sections of said clips wherein said channel is configured to insertably receive an inner side of a top edge of a bed on a truck having said second end of said clips being directed upwardly from the top edge of the bed of the truck;
said clips each having a pair of second bends located on each of said first and second lateral sides of said clips such that said second bends are positioned between said first bends and said second end of said clips to define a third section of said clips, said third section of said clips being directed forwardly from said second section of said clips such that said third section of said clips is configured to abut a bottom surface of a top side of the top edge of the bed of the truck, an upper portion of each said first section being angled relative to a lower portion of said first section such that said upper portion extends over said third section; and
wherein said first section of said clips is configured to have a strap coupled thereto such that the strap secures a load in the bed of the truck.
